(19) United States
(12) Patent Application Publication
(10) Pub. No.: US 2015/0093285 A1
(43) Pub. Date: Apr. 2, 2015

(54) MAGNETIC MATERIAL, USE THEREOF AND METHOD FOR PRODUCING SAME

(71) Applicant: Robert Bosch GmbH, Stuttgart (DE)

(72) Inventors: Stefan Hinderberger, Stuttgart (DE); Christian Wegierski, Aalen (DE); Peter Barth, AM Tilburg (DE); Gerhard Schneider, Ebersbach (DE); Arne Huber, Boeblingen (DE); Juergen Oberle, Sindelfingen (DE); Dagmar Goll, Pluderhausen (DE); Friederike Koeppen, Asperg (DE); Lars Bommer, Leonberg (DE); Roland Stein, Aalen (DE); Markus Raith, Heidenheim (DE); Alberto Martinez-Limia, Ditzingen (DE); Roman Karimi, Aalen (DE); Ingrid Wuehrl, Gerlingen (DE); T-akashi Shigematsu, Saitama (JP)

(21) Appl. No.: 14/398,511

(22) PCT Filed: Apr. 19, 2013
(86) PCT No.: PCT/EP2013/058147

§ 371 Date: Nov. 3, 2014

(30) Foreign Application Priority Data
May 2, 2012 (DE) 10 2012 207 308.6

(51) Int. Cl. H01F 1/053; C22C 38/12; C21D 6/00; C22C 33/04; C21D 9/00; C21D 1/26; H01F 41/02; C22C 38/00

(52) U.S. Cl. CPC H01F 1/053; H01F 41/0253; C22C 38/12; C22C 38/005; C22C 33/04; C21D 9/0068; C21D 1/26; C21D 6/00
USPC 420/83; 75/433; 75/10.66; 148/101

(57) ABSTRACT

The present invention relates to a magnetic material, which contains at least one transition metal (TM), at least one rare earth metal (RE) and tungsten, wherein the proportion of transition metal (TM) is 60 to 90% by mass, the proportion of rare earth metal (RE) is 10 to 20% by mass, and the proportion of tungsten (W) is 5 to 25% by mass, in each case in relation to the total mass of the magnetic material.

### BACKGROUND OF THE INVENTION

The present invention relates to a magnetic material, to the use thereof and also to a method for producing the magnetic material.

As a result of the recently increased use of electric motors, not least in the construction of motor vehicles, the demand for high-efficiency magnetic materials, and in particular for permanent magnets, has risen greatly over recent years. In this respect, suitable magnetic materials include those with magnetically hard phases, which are distinguished by a high remanent magnetization, a large coercive field and a large energy product. The better the magnetic properties of the magnetic material, the more advantageous the use thereof particularly in apparatuses of reduced installation space, said magnetic material being used, for example, in the electrification of drive trains of motor vehicles. Magnetic materials which have a high efficiency, are permanently stable and in this respect are costly are therefore key components of electromobility. Magnetic materials which comprise at least one rare earth metal, such as neodymium (Nd), praseodymium (Pr) and samarium (Sm), and also at least one transition metal, such as iron (Fe) or cobalt (Co), have proved to be particularly efficient, i.e. have proved to have a large energy product. It is often the case that materials of this type are mixed with interstitial additives, such as for example boron (B), carbon (C), nitrogen (N) or hydrogen (H), to optimize the microstructure and therefore also the intrinsic magnet properties. Nd₂Fe₁₄B has proved to be a particularly efficient magnetic material. On account of its limited chemical, mechanical and thermal long-term stability, however, the complete replacement of the conventional ferrites with Nd₂Fe₁₄B has not yet occurred. A further disadvantage of Nd₂Fe₁₄B is the high raw material and production costs thereof. Moreover, the availability of rare earth metals in such a great quantity is greatly limited and is dominated in particular by the market in China, as a result of which the production quantities of magnets on the basis of magnetic materials with high rare earth metal contents, such as even Nd₂Fe₁₄B, are greatly limited.

### SUMMARY OF THE INVENTION

The magnetic material according to the invention is distinguished by outstanding magnetic properties, and therefore a high remanent magnetization, a high coercive field strength and also a large energy product. The mechanical, magnetic and thermal stability of said magnetic material is high, and this predestines it for use in apparatuses subject to high levels of loading, i.e. for example mobile apparatuses, such as motor vehicles and mobile electronic appliances. The use of at least one transition metal (TM), at least one rare earth metal (RE) and tungsten, the proportion of transition metal being 60 to 90% by mass, the proportion of rare earth metal being 10 to 20% by mass and the proportion of tungsten being 5 to 25% by mass, in each case in relation to the total mass of the magnetic material, provides a high-efficiency magnetic material which is distinguished by particularly good physical, chemical and also mechanical properties, and in particular by outstanding magnetic properties. The use of tungsten as a metal essential to the invention in particular makes a decisive contribution here to the stabilization of the lattice microstructure of the magnetic material. Moreover, tungsten supports the anisotropic characteristic of the magnetic phases and thus promotes the desired magnetic properties. The availability of the raw materials is ensured by the reduced content of rare earth metals and the flexibility in the selection of the rare earth metals and transition metals to be combined with tungsten, as a result of which shortfalls in supply can be efficiently avoided and the production quantities are not subject to any limitations. This also reduces the raw material costs of the material according to the invention considerably compared to conventional magnetic materials with high rare earth metal contents. On account of the specific composition according to the invention, it is therefore also possible to lower the production costs of the material according to the invention, and this greatly increases the market acceptance thereof. The use of the magnetic material according to the invention consequently opens up multiple possible uses also in low-price products, without having a disadvantageous effect on the quality properties thereof.

According to an advantageous embodiment of the invention, the transition metal is selected from the group consisting of: iron (Fe), cobalt (Co), nickel (Ni) and manganese (Mn), and is preferably Fe. The transition metals named here form, together with rare earth metals and tungsten, particularly stable lattice structures, and make a greater contribution to the characteristic of the desired advantageous magnetic properties, i.e. in particular to the saturation and magnetic anisotropy of the material according to the invention. Furthermore, these transition materials are readily available on the market, and the raw material costs thereof are low, and this reduces the production costs of the magnetic material according to the invention considerably. The preferred use of Fe from among these metals can be attributed to its harmlessness in terms of health and ecology and moreover also to its raw material costs, which are once again reduced considerably compared to Co, Ni and Mn.

According to a further advantageous embodiment of the present invention, the rare earth metal (RE) is selected from the group consisting of: neodymium (Nd), lanthanum (La), cerium (Ce), dysprosium (Dy), terbium (Tb), praseodymium (Pr), samarium (Sm), promethium (Pm), europium (Eu), yttrium (Y), scandium (Sc), gadolinium (Gd), holmium (Ho), erbium (Er), thulium (Tm), ytterbium (Yb) and lutetium (Lu), and is preferably Ce and/or La. The rare earth metals listed, Nd, La, Ce, Dy, Tb, Pr, Sm, Pm, Eu, Y, Sc, Gd, Ho, Er, Tm, Yb and Lu, have proved to be particularly readily compatible with the further components essential to the invention, i.e. the at least one transition metal and tungsten, and for their part promote the formation of permanently stable crystal lattice structures with high anisotropy, as a result of which the magnetic properties of the magnetic material according to the invention are improved. In spite of the in some cases higher raw material costs thereof, the production costs of the magnetic material according to the invention are lower on account of their reduced content, compared to conventional magnetic materials, in the magnetic composition according to the invention. On account of the particularly high availability and relatively low raw material costs, the use in particular of the elements La and Ce is particularly advantageous for the present invention.

According to a further advantageous embodiment of the present invention, the proportion of transition metal is 60 to 70% by mass, preferably 61 to 67% by mass, further preferably 63 to 65% by mass and/or the proportion of rare earth metal is 13 to 19% by mass, preferably 15 to 17% by mass and/or the proportion of tungsten is 10 to 25% by mass, preferably 14 to 23% by mass, further preferably 16 to 21% by mass, in relation to the total mass of the magnetic material. If the proportion of transition metal is at least 60% by mass and preferably at least 61% by mass or further preferably 63% by mass and/or the proportion of tungsten is at least 10% by mass or preferably at least 14% by mass and in particular at least 16% by mass, a high-efficiency, mechanically, chemically and thermally stable magnetic material is obtained, which has only a very low content of rare earth metal, nevertheless has outstanding magnetic properties and in particular a large energy product, and consequently is also preferred in respect of its raw material costs and therefore also in respect of its production costs. Above a content of the transition metal of more than 65% by mass and in particular of more than 67% by mass and in particular of more than 70% by mass, however, the stability of the crystal lattice structure of the magnetic material decreases. This also applies to a content of tungsten of more than 21% by mass and in particular more than 23% by mass and in particular of more than 25% by mass. If the proportion of rare earth metal is 13 to 19% by mass and preferably 15 to 17% by mass, the remanent magnetization and also coercive field strength of the magnetic material according to the invention can be maximized.

According to a further advantageous embodiment of the present invention, the structure of the magnetic material according to the invention is selected from: an RE(TM, W)₁₂ structure, a Th₂Zn₁₇ structure such as RE₂(TM, W)₁₇ and an RE₃(TM, W)₂₉ structure. The structures listed here have proved to be particularly effective for the formation of anisotropic phases of the magnetic material according to the invention. This can be attributed to the advantageous electron structure and electron configuration thereof and also the spin moments and angular moments of the atoms.

A further advantageous embodiment of the invention provides for the presence of at least one further element selected from the group consisting of: nitrogen (N), carbon (C) and hydrogen (H). The elements named here are interstitial additives, that is to say they occupy interstitial sites of the crystal lattice structures, as a result of which the crystal lattice of the magnetic material is widened and stabilized in a particularly effective manner. This contributes to an improvement in the magnetic properties of the material according to the invention and increases, in particular, the magnetization, the Curie temperature and the anisotropy of the magnetic material.

It is further preferable that the magnetic material according to the invention preferably contains at least one further element selected from the group consisting of: vanadium (V), copper (Cu), chromium (Cr), tin (Sn), aluminum (Al), silicon (Si), molybdenum (Mo), gallium (Ga), titanium (Ti), zinc (Zn), niobium (Nb) and zirconium (Zr). These elements can have a positive effect on the magnetic and also physical and chemical properties of the material and the resistance thereof, i.e. the chemical and electrochemical resistance thereof (e.g. corrosion resistance). In particular, the elements Cu, Ga and Al here improve the wetting of the magnetically hard grains by the grain boundary phase in the case of sintered magnets.

A permanent magnet comprising a magnetic material as explained above is furthermore also described according to the invention. The material according to the invention is preferably present in the permanent magnet according to the invention as a magnetically hard phase. In addition to the magnetic material according to the invention, the permanent magnet according to the invention can comprise further magnetic or non-magnetic phases, but can also consist only of the magnetic material according to the invention. It is preferable that the permanent magnet comprises a magnetically hard phase, as described above, consisting of at least one transition metal (TM), at least one rare earth metal (RE) and tungsten, the proportion of transition metal (TM) being 60 to 90% by mass, the proportion of rare earth metal (RE) being 10 to 20% by mass and the proportion of tungsten (W) being 5 to 25% by mass, in each case in relation to the total mass of the magnetic material, in which case, by way of example, the permanent magnet can be sintered in a conventional sense or plastic-bonded. The advantageous effects, advantages and embodiments described for the magnetic material according to the invention also apply to the permanent magnets according to the invention.

A method for producing a magnetic material is likewise also described according to the invention, the method being characterized by the steps of mixing at least one transition metal (TM), at least one rare earth metal (RE) and tungsten, the proportion of transition metal (TM) being 60 to 90% by mass, the proportion of rare earth metal (RE) being 10 to 20% by mass and the proportion of tungsten (W) being 5 to 25% by mass, in each case in relation to the total mass of the magnetic material, and of melting the mixture obtained. The method according to the invention provides a high-efficiency magnetic material having an outstanding remanent magnetization and coercive field strength and also a large energy product in a simple and inexpensive manner, said material further having a very good mechanical, chemical and also thermal stability. The advantageous properties, effects and embodiments described for the magnetic material according to the invention also apply to the method according to the invention for producing such a magnetic material.

According to a preferred embodiment of the method according to the invention, the mixture of the elements essential to the invention is melted in an arc or in a vacuum furnace. This procedure ensures that all elements are melted completely without oxidation of the material, and therefore this is followed by the formation of a homogeneous crystal microstructure of the magnetic material, which not only has an advantageous effect on the mechanical stability of the magnetic material which forms, but also characterizes the desired magnetic properties to a significant extent.

According to a further advantageous embodiment, a step which follows the melting involves a heat treatment at a temperature of between 500° C. and 1500° C., preferably of between 700° C. and 1100° C., for a duration of 10 min up to 2 weeks, and preferably for one hour up to 25 hours. This heat treatment, which is preferably carried out under a protective gas atmosphere, and in particular under argon, promotes the complete formation of the magnetic material preferably as a magnetically hard phase.

According to a further advantageous embodiment of the method according to the invention, the mixture obtained is ground and/or subjected to nitriding in a subsequent step after the melting or once the heat treatment has been carried out. The grinding of the mixture obtained promotes the further processability thereof, for example to give a plastic-bonded magnetic material. Nitriding can improve the magnetic properties of the material, and in particular the anisotropy thereof. It is particularly advantageous that the mixture obtained is firstly ground and then nitrided, since it is possible in this way to achieve uniform nitriding even to an ultrafine grain size, as a result of which the magnetic properties of the resulting material are improved to a particularly great extent.

The use of a magnetic material as stated above preferably in wind power plants, passenger vehicles, commercial vehicles, starters, electric motors, loudspeakers and microelectromechanical systems is furthermore also described according to the invention. On account of the outstanding magnetic properties of the magnetic material according to the invention, and also the outstanding stability thereof, and therefore also the ability thereof to be used in the case of a reduced installation space, the use in said apparatuses is particularly advantageous.

An electric machine, in particular a generator, motor vehicle, starter, electric motor, loudspeaker or microelectromechanical system, containing the magnetic material according to the invention or a magnetic material which has been produced by the above method according to the invention, is furthermore described according to the invention.

The advantages, advantageous effects and preferred embodiments described for the magnetic material according to the invention and also the method according to the invention also apply to the electric machine according to the invention.

### BRIEF DESCRIPTION OF THE DRAWINGS

Exemplary embodiments of the invention will be described in detail hereinbelow with reference to the accompanying drawings, in which:

FIG. 1 shows an optical micrograph of a section of the magnetic material according to the invention in polarized light,

FIG. 2 shows a graph illustrating a first example of a heat treatment according to an advantageous embodiment of the invention, and

FIG. 3 shows a graph illustrating a second example of a heat treatment according to a further advantageous embodiment of the invention.

### DETAILED DESCRIPTION

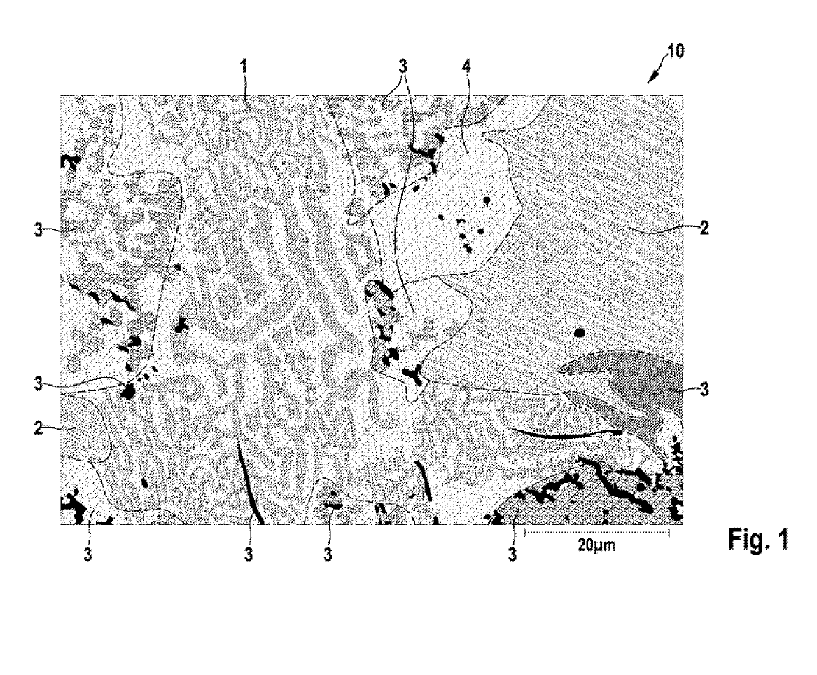

FIG. 1 shows an optical micrograph of a section of the magnetic material 10 according to the invention in polarized light. The material 10 according to the invention contains 16% by mass Ce, 64% by mass Fe and 20% by mass W, and is present predominantly with a Ce(Fe, W)₁₂ structure 1, 2, 4. The magnetically hard Ce(Fe, W)₁₂ phase 1, 2, 4 can be recognized by what is termed the Kerr pattern, i.e. a pattern which, depending on the angle of vision, has a rosette shape or streaky form, this indicating the presence of such a pronounced magnetically hard phase of Ce(Fe, W)₁₂ with high anisotropy. Reference signs 2 and 4 likewise denote, in FIG. 1, a markedly magnetically hard Ce(Fe, W)₁₂ phase, but this is oriented in such a way in relation to the vector of the incident polarized light of the optical microscope that the Kerr pattern cannot be recognized or can be recognized only in slightly streaky form in this direction of vision. In FIG. 1, reference sign 3 denotes merely weakly magnetic or non-magnetic binary or ternary phases, the formation of which can be prevented by the optimization of the process parameters in the process for producing the magnetic material 10 according to the invention. The magnetic material 10 according to the invention is distinguished by a large energy product, a high coercive field strength, a high remanent magnetization and also outstanding mechanical, chemical and thermal properties.

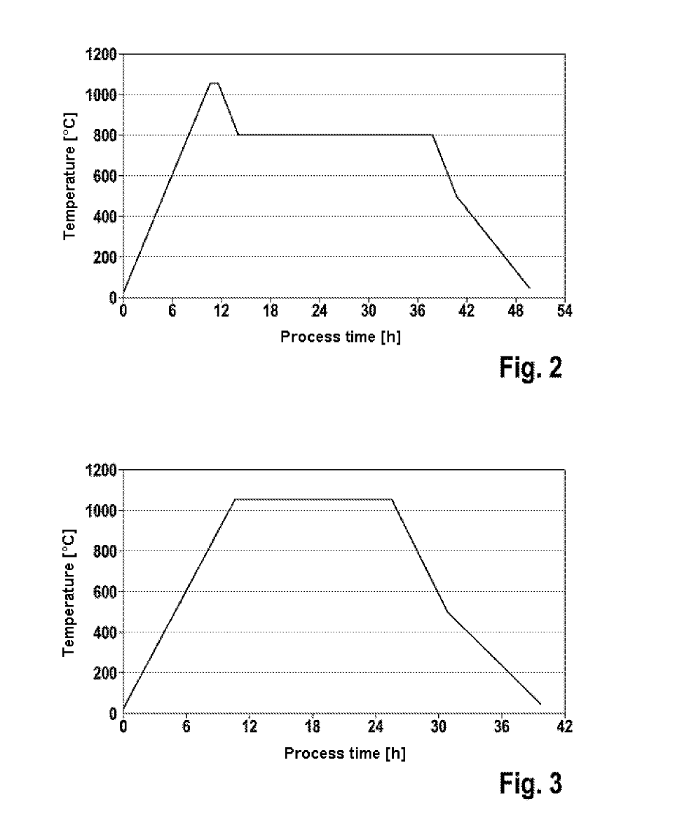

FIG. 2 shows a graph illustrating a first example of a heat treatment according to an advantageous embodiment of the invention. As already stated, the complete manifestation of a magnetically hard phase is ensured by a heat treatment, advantageously under protective gas, which follows, for example, the melting of the elements essential to the invention to form a magnetic material. In a first step, to this end the molten material is heated, after cooling, to 1050° C. over approximately 10 hours in a vacuum furnace, kept at approximately 1050° C. for one hour, and then cooled to approximately 800° C. over approximately 2 hours and kept at 800° C. for 24 hours. Then, the material obtained is gradually cooled to room temperature (approximately 20° C.) over 24 hours. This forms a magnetic material with excellent magnetic properties, i.e. a magnetic material having a completely developed magnetically hard phase, which consists in particular of magnetically hard grains, which is likewise distinguished by an outstanding mechanical, chemical and thermal stability.

FIG. 3 shows a graph illustrating a second example of a heat treatment according to a further advantageous embodiment of the invention. This heat treatment, too, is carried out in turn following the melting of the elements essential to the invention to form a magnetic material, advantageously under protective gas. In this case, too, complete manifestation of a magnetically hard phase is ensured. In a first step, to this end the molten material is heated to 1050° C. in a vacuum furnace, kept at approximately 1050° C. for 15 hours, and then gradually cooled to room temperature (approximately 20° C.). This too forms magnetically hard grains with high magnetic anisotropy, i.e. a magnetic material with a completely developed magnetically hard phase, which is therefore distinguished by outstanding magnetic properties and an outstanding mechanical, chemical and thermal stability. In this exemplary embodiment, the procedure is simplified by the more continuous temperature profile.

1. A magnetic material containing at least one transition metal (TM), at least one rare earth metal (RE) and tungsten, the magnetic material having a proportion of transition metal (TM) that is 60 to 90% by mass, a proportion of rare earth metal (RE) that is 10 to 20% by mass and a proportion of tungsten (W) that is 5 to 25% by mass, in each case in relation to a total mass of the magnetic material.

2. The magnetic material as claimed in claim 1, characterized in that the transition metal (TM) is selected from the group consisting of: Fe, Co, Ni and Mn.

3. The magnetic material as claimed in claim 1, characterized in that the rare earth metal (RE) is selected from the group consisting of: Nd, La, Ce, Dy, Tb, Pr, Sm, Pm, Eu, Y, Sc, Gd, Ho, Er, Tm, Yb and Lu.

4. The magnetic material as claimed in claim 1, characterized in that the proportion of transition metal (TM) is 60 to 70% by mass, and/or the proportion of rare earth metal (RE) is 13 to 19% by mass, and/or the proportion of tungsten (W) is 10 to 25% by mass, in each case in relation to the total mass of the magnetic material.

5. The magnetic material as claimed in claim 1, characterized in that the structure of the magnetic material is selected from: an RE(TM,W)₁₂ structure, a Th₂Zn₁₇ structure such as RE₂(TM,W)₁₇ and an RE₃(TM,W)₂₉ structure.

6. The magnetic material as claimed in claim 1, characterized in that the magnetic material contains at least one further element selected from the group consisting of: N, C and H.

7. The magnetic material as claimed in claim 1, characterized in that the magnetic material contains at least one further element selected from the group consisting of: V, Cu, Cr, Sn, Al, Si, Mo, Ga, Ti, Zn, Nb and Zr.

8. A permanent magnet comprising at least one magnetic material as claimed in claim 1.

9. A method for producing a magnetic material by mixing at least one transition metal (TM), at least one rare earth metal (RE) and tungsten to obtain a mixture, with a proportion of transition metal (TM) being 60 to 90% by mass, a proportion of rare earth metal (RE) being 10 to 20% by mass and a proportion of tungsten (W) being 5 to 25% by mass, in each case in relation to a total mass of the magnetic material, and melting the mixture.

10. The method as claimed in claim 9, characterized in that the melting is effected in an arc or in a vacuum furnace.

11. The method as claimed in claim 9, characterized in that a step which follows the melting involves a heat treatment at a temperature of between 500° C. and 1500° C., for a duration of 10 min up to 2 weeks.

12. The method as claimed in claim 9, characterized in that a further step involves the mixture obtained being ground and/or subjected to nitriding.

13. (canceled)

14. An electric machine, containing a magnetic material as claimed in claim 1.

15. An electric machine as claimed in claim 14, wherein the machine is a generator, motor vehicle, starter, electric motor, loudspeaker or micro electromechanical system.

16. An electric machine as claimed in claim 14, wherein the magnetic material is part of a permanent magnet.

17. The magnetic material as claimed in claim 1, characterized in that the transition metal (TM) is Fe.

18. The magnetic material as claimed in claim 1, characterized in that the rare earth metal (RE) is selected from the group consisting of Ce and/or La.

19. The magnetic material as claimed in claim 1, characterized in that the proportion of transition metal (TM) is 61 to 67% by mass, and/or the proportion of rare earth metal (RE) is 15 to 17% by mass and/or the proportion of tungsten (W) is 14 to 23% by mass, in each case in relation to the total mass of the magnetic material.

20. The magnetic material as claimed in claim 1, characterized in that the proportion of transition metal (TM) is 63 to 65% by mass and/or the proportion of rare earth metal (RE) is 15 to 17% by mass and/or the proportion of tungsten (W) is 16 to 21% by mass, in each case in relation to the total mass of the magnetic material.

21. The method as claimed in claim 9, characterized in that a step which follows the melting involves a heat treatment at a temperature of between 700° C. and 1100° C., for a duration of one hour up to 25 hours.
